(19) United States
(12) Patent Application Publication
(10) Pub. No.: US 2018/0082306 A1
(43) Pub. Date: Mar. 22, 2018

(54) SYSTEMS AND METHODS FOR PROVIDING REAL-TIME ALERTS WITH CONCESSIONS

(71) Applicant: Capital One Financial Corporation, McLean, VA (US)

(72) Inventors: William Hanson, Sandy Hook, VA (US); Olivier Hecht, Richmond, VA (US); Scott Melody, Glen Allen, VA (US); Jerome Spellman, Glen Allen, VA (US); Kurt Schoenberg, Powhatan, VA (US)

(73) Assignee: Capital One Financial Corporation, McLean, VA (US)

(21) Appl. No.: 15/826,199

(22) Filed: Nov. 29, 2017

Related U.S. Application Data
(63) Continuation of application No. 14/824,191, filed on Aug. 12, 2015.
(60) Provisional application No. 62/036,153, filed on Aug. 12, 2014.

(51) Int. Cl. G06Q 30/00; G06F 11/07; G06F 9/44

(52) U.S. Cl. CPC G06Q 30/012; G06F 11/0793; G06F 11/0781; G06F 11/0748; G06F 11/0742; G06F 9/44

(57) ABSTRACT

The disclosed embodiments include a method for generating a response when a user encounters an error while using a servicing system. The method may include determining a user has encountered an error using a servicing system based on a trigger event associated with a system failure, logging the error in association with identifying information of the user, analyzing the error according to one or more pre-configured rules to determine an error level associated with the error, and selecting one or more responses to the error based on the error level, with at least one response being directed to the user in real-time. The method may include determining a medium for transmitting the one or more responses based on a type of device operated by the user when the user encountered the error, and transmitting the one or more responses using at least the determined medium.

### PRIORITY CLAIM

This disclosure claims priority under 35 U.S.C. § 119 to U.S. provisional patent application No. 62/036,153 filed on Aug. 12, 2014. The aforementioned application is incorporated herein by reference in its entirety.

### BACKGROUND

Companies have increasingly enabled their customers to conduct transactions using new methods, providing additional convenience and functionality. For instance, customers of financial institutions (e.g., banks, credit card companies, investment firms, etc.) are typically provided tools to perform account transactions over the Internet using a computer or mobile device. For example, customers may submit payments, modify their profile, and/or interact with customer service representatives without entering a brick and mortar establishment of their financial institution. When performing such transactions, customers sometimes encounter errors that prevent them from completing their attempted task. While attempting to submit a payment, for instance, a customer may receive a generic error message (e.g., “system error, try again later,” “this service is currently unavailable,” “error code: 403”) indicating that the payment was not successfully submitted. Customers may experience frustration and confusion when receiving such a message, especially when the message does not present any explanation of, or solution to, the problem, and the user is left unable to perform the desired transaction.

In addition, customers experiencing errors are likely to call, e-mail, or otherwise contact their financial institution to seek assistance in conducting the desired transaction. Providing assistance to customers in this manner, however, is costly, and the cost to the business increases as the volume of those contacting the business for assistance increases. Furthermore, customers who contact the business for assistance do not necessarily experience an ideal resolution to their problems. For example, a customer who is unsuccessful in submitting an online payment via a desired payment method (e.g., electronic funds transfer), may instead be offered an alternative payment method considered less desirable (e.g., check, wire transfer, etc.).

Current computing systems and supporting infrastructures are ill-equipped to address these and similar issues. There is therefore a need for computing systems capable of quickly and efficiently addressing problems experienced by users of servicing systems while reducing costs associated with communicating with those users to address those problems.

### SUMMARY

In one embodiment, a system for generating a response when a user encounters an error while using a servicing system is disclosed that may include, for example, one or more memory devices storing instructions and one or more hardware processors configured to execute the instructions to perform operations including determining a user has encountered an error using a servicing system based on a trigger event, wherein the trigger event is associated with one or more system failures. The operations my also include logging, in a database associated with the servicing system, the error in association with identifying information of the user, and analyzing the error according to one or more pre-configured rules to determine an error level associated with the error, the error level being based in part on an error history associated with the user.

The operations may also include selecting, based on the error level, one or more responses to the error, wherein at least one response from the one or more responses is directed to the user in real-time. The operations may also include determining a medium for transmitting the one or more responses based on a type of device operated by the user when the user encountered the error and transmitting the one or more responses using at least the determined medium.

The disclosed embodiments may also include a computer-implemented method for generating a response when a user encounters an error while using a servicing system. The method may include determining, using at least one processor, a user has encountered an error using a servicing system based on a trigger event, wherein the trigger event is associated with one or more system failures. The method may also include logging, by the at least one processor, the error in association with identifying information of the user in a database associated with the servicing system, analyzing, by the at least one processor according to one or more pre-configured rules, the error to determine an error level associated with the error, the error level being based in part on an error history associated with the user, and selecting, by the at least one processor, one or more responses to the error based on the error level, wherein at least one response from the one or more responses is directed to the user in real-time. The method may also include determining, by the at least one processor, a medium for transmitting the one or more responses based on a type of device operated by the user when the user encountered the error, and transmitting, by the at least one processor, the one or more responses using at least the determined medium.

Aspects of the disclosed embodiments may include tangible computer-readable media that stores software instructions that, when executed by one or more processors, are configured to and capable of performing and executing one or more of the methods, operations, and the like consistent with the disclosed embodiments. Also, aspects of the disclosed embodiments may be performed by one or more processors configured as special-purpose processor(s) based on dedicated hardware configurations and/or software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a diagram of another exemplary system, consistent with disclosed embodiments.

FIG. 3 is a diagram of another exemplary system, consistent with disclosed embodiments.

FIG. 4 is a flow chart of an exemplary process for generating a response when a user encounters an error, consistent with disclosed embodiments.

FIG. 5 is a flow chart of an exemplary error analysis process, consistent with disclosed embodiments.

FIG. 6 is a flow chart of an exemplary process for determining which actions to take in response to a user-encountered error, consistent with disclosed embodiments.

FIG. 7 is a flow chart of an exemplary process for determining whether to offer a reward to a user, consistent with disclosed embodiments.

FIG. 8 is a flow chart of another exemplary error analysis process, consistent with disclosed embodiments.

FIGS. 9A, 9B, and 9C are exemplary graphical user interfaces for displaying messages to a user, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments may include systems and processes that provide a real-time application programming interface (API) for generating a response when a user of a financial service provider system encounters an error while interfacing with a servicing system, such as a payment system. In one aspect, a real-time API consistent with certain disclosed embodiments may use Representational State Transfer (REST) style architecture, and in this scenario, the real-time API may be referred to as a RESTful API. Thus, for example, the API may allow for consistent messaging and notification to users across one or more digital channels (e.g., push notification, browser pop-ups, e-mail, SMS, text message, etc.).

In one aspect, the real-time API may include a set of Hypertext Transfer Protocol (HTTP) request messages and a definition of the structure of response messages. The API may allow a software application that is written against the API and installed on a client (e.g., a computing device associated with a user) to exchange data with a server (e.g., a computing system associated with a financial service provider) that implements the API, in a request-response pattern. In one aspect, the request-response pattern defined by the API may be configured in a synchronous fashion and respond in real-time. A response message from the server to the client through the API consistent with the disclosed embodiments may be in a particular format such as, for example, Extensible Markup Language (XML), JavaScript Object Notation (JSON), and/or the like.

For ease of discussion, the disclosed embodiments have been described in the context of the financial service industry and, in particular, with respect to financial institutions (e.g., banks, credit card companies, investment firms, etc.). It should be understood, however, that the disclosed embodiments are not limited to the financial service industry and financial institutions. For example, aspects of the disclosed embodiments may be applied to e-commerce businesses (e.g., retail stores with an established Internet presence), the travel industry (e.g., airlines, hotels, and associated rewards or loyalty programs), restaurant businesses, or any other industry or entity where users interact with servicing systems.

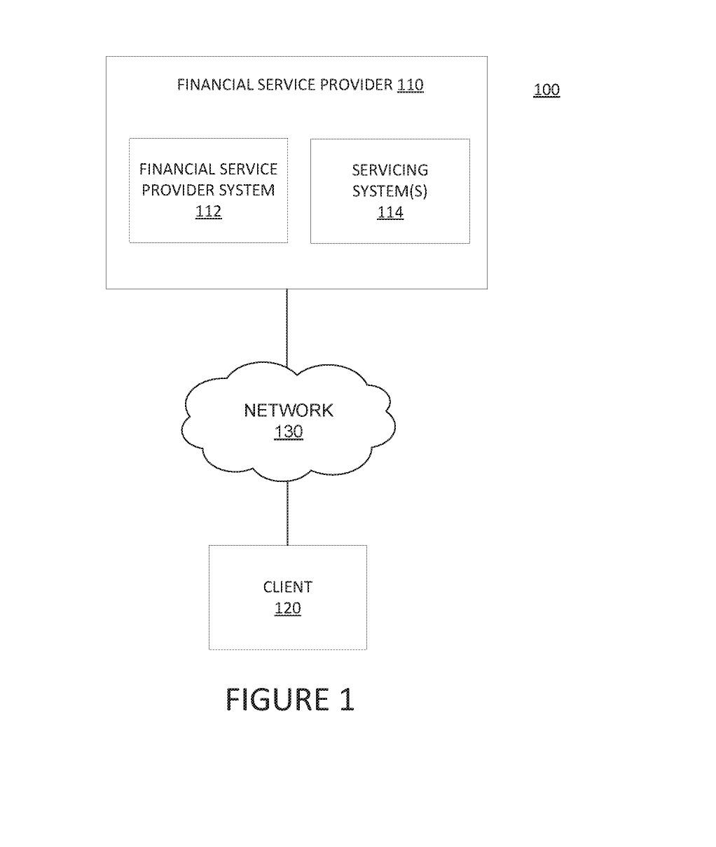

FIG. 1 is a block diagram of an exemplary system 100 for performing one or more operations consistent with the disclosed embodiments. In one aspect, system 100 may include one or more financial service providers 110, one or more clients 120, and network 130. The components and arrangement of the components included in system 100 may vary. Thus, system 100 may include other components that perform or assist in the performance of one or more operations consistent with the disclosed embodiments.

Components of system 100 may be computing systems configured to generate a response when a user encounters an error, such as an error encountered by a user while using a servicing system 114, consistent with disclosed embodiments. As further described herein, components of system 100 may include one or more computing devices (e.g., computer(s), server(s), embedded systems or other dedicated hardware computing devices, etc.), memory storing data and/or software instructions (e.g., database(s), memory devices, etc.). The one or more computing devices may be configured to execute software instructions stored on one or more memory devices to perform one or more operations consistent with the disclosed embodiments. Components of system 100 may be configured to communicate with one or more other components of system 100, including systems associated with financial service provider 110 and/or client 120. In certain aspects, users may operate one or more components of system 100 to initiate and/or provide input for one or more operations consistent with the disclosed embodiments. Throughout this disclosure, for example, users may be understood as operating client 120 to interact with financial service provider 110.

Financial service provider 110 may be an entity that provides, maintains, manages, or otherwise offers financial services. For example, financial service provider 110 may be a bank, credit card issuer, or any other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. Financial service provider 110 may include infrastructure and components that are configured to generate and/or provide financial service accounts such as credit card accounts, checking accounts, debit card accounts, loyalty or reward programs, lines of credit, and the like.

Financial service provider 110 may include one or more financial service provider systems 112. In one aspect, financial service provider system 112 may be one or more computing devices configured to perform one or more operations consistent with disclosed embodiments. In one aspect, financial service provider system 112 may be an embedded system or other dedicated hardware computing device. Financial service provider system 112 may include one or more processors configured to execute software instructions stored in memory. The one or more processors may be configured to execute software instructions to perform known Internet-related communications and financial service-based processes. For instance, financial service provider system 112 may execute software that provides data used for generating and displaying interfaces, including content on a display device included in, or connected to, client 120. Financial service provider system 112 may provide one or more web sites or online portals that are accessible by client 120 over network 130. The disclosed embodiments are not limited to any particular configuration of financial service provider system 112.

Financial service provider 110 may include one or more servicing systems 114. In one aspect, servicing systems 114 may be one or more computing devices configured to perform one or more operations consistent with disclosed embodiments. Servicing systems 114 may include one or more processors configured to execute software instructions stored in memory. The one or more processors may be configured to execute software instructions to perform known Internet-related communications, database management, financial service-based processes, and/or servicing-related functions. For instance, servicing systems 114 may execute software that provides users (via client 120) with the ability to conduct financial transactions, such as submitting payments, transferring funds, setting up direct deposits, viewing account activity, updating contact information, etc. The disclosed embodiments are not limited to any particular configuration of servicing systems 114.

Client 120 may be one or more computing devices configured to perform one or more operations consistent with disclosed embodiments. Client 120 may be a desktop computer, a laptop, a server, a mobile device (e.g., tablet, smart phone, etc.), or any other type of computing device. For exemplary purposes, aspects of the disclosed embodiments are described with reference to client 120 as a mobile client device, such as a smart phone, tablet, or the like. As discussed herein, however, the disclosed embodiments are not limited to such examples.

Client 120 may include one or more processors configured to execute software instructions stored in memory, such as memory included in client 120. Client 120 may include software that, when executed by a processor, enables known Internet-related communications, content display processes, and financial service-related processes for a user of client 120. For instance, client 120 may execute browser or related mobile display software to generate and display interfaces including content on a display device included in, or in communication with, client 120. In addition, client 120 may be configured to receive communications (e.g., from financial service provider system 112) through various digital channels, such as push notification, browser pop-ups, e-mail, SMS, text message, and the like.

Client 120 may be a mobile device that executes mobile device applications and/or mobile device communication software that allows client 120 to communicate with components over network 130, and generate and display content in interfaces via a display device included in client 120. The disclosed embodiments are not limited to any particular configuration of client 120. For instance, client 120 may be a mobile device that stores and executes mobile applications that provide financial service-related functions offered by financial service provider system 112, such as an associated mobile banking application for checking balances, changing user account profiles, performing financial transactions, receiving marketing messages, etc. In certain embodiments, client 120 may be configured to execute software instructions relating to location services, such as GPS locations. For example, client 120 may be configured to determine a geographic location of client 120 (and associated user) and provide location data and time stamp data corresponding to the location data.

Network 130 may be any type of network configured to provide an electronic medium for communications between components of system 100. For example, network 130 may be any type of network (including infrastructure) that provides communications, exchanges information, and/or facilitates the exchange of information, such as the Internet, a Local Area Network, NFC, or other suitable connection(s) that enables the sending and receiving of information between the components of system 100. In other embodiments, one or more components of system 100 may communicate directly through a dedicated communication link(s), such as links between financial service provider 110 and client 120.

It is to be understood that the configuration and boundaries of the functional building blocks of system 100 have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, financial service provider system 112 may constitute components of system 100 other than those specifically described, or may constitute a part of multiple components of system 100 (i.e., a distributed system). Moreover, servicing systems 114 may be separate and distinct from financial service provider 110 and be operated by, for example, a third-party having access to customer-specific information. Such alternatives fall within the scope and spirit of the disclosed embodiments.

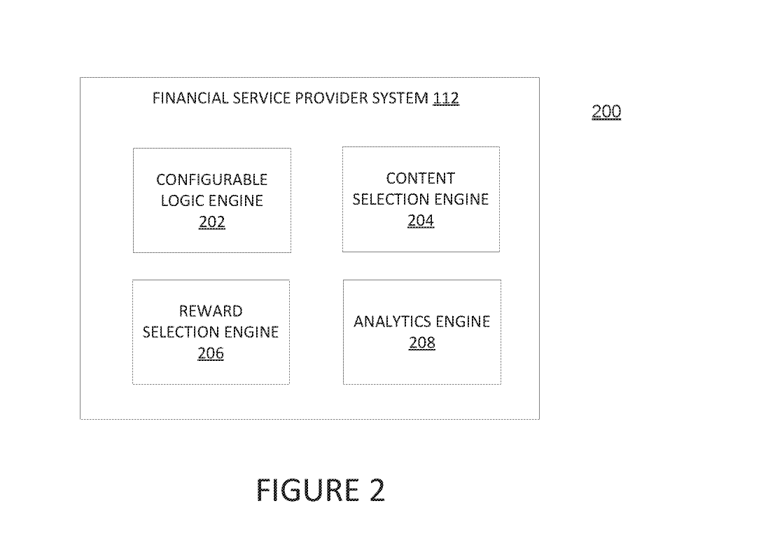

FIG. 2 is a block diagram of an exemplary system 200 for performing one or more operations consistent with the disclosed embodiments. Variations of exemplary system 200 may be incorporated into, for example, financial service provider system 112. In one aspect, system 200 may include a configurable logic engine 202, a content selection engine 204, a reward selection engine 206, and an analytics engine 208. In some embodiments, system 200 may be configured as a particular apparatus, embedded system, dedicated circuit, and the like based on the storage, execution, and/or implementation of the software instructions that perform one or more operations consistent with the disclosed embodiments.

Exemplary system 200 may include a configurable logic engine 202. In one aspect, configurable logic engine 202 may be one or more computing devices configured to perform one or more operations consistent with disclosed embodiments. In one aspect, configurable logic engine 202 may execute software to perform one or more logical operations corresponding to pre-configured rules. Exemplary pre-configured rules may include recipient rules reflecting user preferences as to notification settings, delivery options, message format settings, message content settings, and the like. For example, recipient rules may indicate that a user prefers to enable e-mail notifications for messages containing system status updates. As another example, pre-configured rules may include numerical rankings associated with different types of errors. Thus, configurable logic engine 202 may use logical operations to determine a ranking to associate with a particular error (e.g., reflecting the seriousness of the error relative to other errors, etc.) encountered by a user. For example, the pre-configured rules may assign rankings between 1-5 to different types errors (e.g., 1 being “minor error,” and 5 being “serious error), such that an error associated with processing payment transaction may be ranked a “5”, while an error associated with a user selecting a “go paperless” delivery profile setting may be ranked a “1.” Configurable logic engine 202 may also use pre-configured rules to determine the manner in which to respond to an error encountered by a user. For example, in some embodiments, configurable logic engine 202 may determine, based on the pre-configured rules and in conjunction with content selection engine 204, that errors with a “5” ranking merit an immediate message to the user at the device the user is operating when the error occurred. Similarly, the configurable logic engine 202 may determine, based on the pre-configured rules and in conjunction with content selection engine 204, to e-mail the user for errors with a ranking of “1” regardless of the user's communication preferences or which device the user may be operating at the time of the error. In one aspect, configurable logic engine 202 may interact with content selection engine 204 and/or reward selection engine 206 to make such determinations. Thus, configurable logic engine 202 may receive data associated with a user profile and/or an error encountered by the user from content selection engine 204 or reward selection engine 206 to determine, for example, an error level to associate with the error, how financial service provider system 112 should respond to the error, and/or whether financial service provider system 112 should offer the user a reward.

In one aspect, configurable logic engine 202 may perform one or more logical operations to determine an error level for an error encountered by a user while using servicing system 114. The error level may reflect information about the error such as the type (e.g., payment system error, database access error, etc.), frequency of occurrence (e.g., the number of times a particular user and/or users in general have encountered the error, over time), and relative significance of the error (e.g., prevents users from completing desired transactions for undetermined period of time, minor website malfunction with readily available alternative, etc.). Thus, configurable logic engine 202 may use logical operations based on different factors (e.g., pre-configured rules such as recipient rules, numerical rankings, information associated with a user-encountered error, metrics or statistical measures associated with the error, etc.) to arrive at an error level to associate with the error. In one aspect, the logical operations performed by configurable logic engine 202 may be modified. For example, financial service provider system 112 (via system engineers, technical support staff, etc.) may include logical operations involving additional recipient rules or more specific error characteristics. The disclosed embodiments are not limited to any particular configuration of configurable logic engine 202.

Exemplary system 200 may include a content selection engine 204. In one aspect, content selection engine 204 may be one or more computing devices configured to perform one or more operations consistent with disclosed embodiments. Content selection engine 204 may execute software to generate messages for communicating to a user from financial service provider system 112. When a user encounters an error, content selection engine 204 may generate one or more messages based on, for example, information associated with the error (e.g., the type, frequency of occurrence, and relative significance of the error, etc.) and the user's preferences (e.g., notification settings, delivery options, message format settings, message content settings, etc.).

For instance, if a user is unsuccessful in submitting an online payment due to a temporary or one-time system glitch, content selection engine 204 may generate the message “Your payment was not successful due to a minor system error. Please try again momentarily.” On the other hand, if a user is unable to submit an online payment because the payment processing system is offline for maintenance, content selection engine 204 may generate the message “Your payment was not successful as our payment processing system is currently offline and undergoing routine maintenance. We will notify you once maintenance is complete and apologize for any inconvenience.”

In addition, content selection engine 204 may determine the manner of communicating with the user (e.g., via client device 120). That is, content selection engine 204 may determine whether to send a communication to the user via push notification, browser pop-ups, e-mail, SMS, text message, and/or via other digital channels, based on, for example, user preferences and the error level associated with the error. Content selection engine 204 may use logical operations (and may interact with configurable logic engine 202 to perform the operations) in conjunction with information associated with the error and the user's preferences to make this determination and to generate messages.

In one aspect, content selection engine 204 may execute software to determine whether to offer the user a reward, based on, for example, one or more of the factors considered in generating messages described above. Thus, content selection engine 204 may determine whether to offer a reward to the user based on a combination of the error level, the user's transaction history, past errors encountered by the user, and/or metrics and related statistical measures associated with the error. The disclosed embodiments are not limited to any particular configuration of content selection engine 204.

Exemplary system 200 may include a reward selection engine 206. In one aspect, reward selection engine 206 may be one or more computing devices configured to perform one or more operations consistent with disclosed embodiments. Reward selection engine 206 may execute software to determine whether to offer one or more rewards to a user when the user encounters an error. Reward selection engine 206 may make the determination based on, for example, information associated with the error (e.g., the type, frequency of occurrence, and relative significance of the error, etc.) and the user's profile (e.g., transaction history, the number of times the user has called for assistance, spending pattern, etc.).

For instance, reward selection engine 206 may determine that a user encountering a serious error for the fifth time should be offered a reward, whereas a user encountering a relatively minor error (e.g., compared to other errors) for the first time should not be offered a reward. Rewards may include gift cards, bonus loyalty or rewards program points, statement credits, exclusive merchant offers, and the like. Reward selection engine 206 may consider the user's transaction history in determining which reward(s) to offer the user. If the user frequents a particular café, for example, reward selection engine 206 may offer the user a gift card that may be used at the café, or an automatic statement credit for future purchases at the café. Similarly, reward selection engine 206 may offer bonus points to a user who frequently incurs travel-related expenses.

In one aspect, reward selection engine 206 may use a combination of factors to determine whether to offer the user a reward and the size or amount of any offered reward. For instance, reward selection engine 206 may make these determinations based on various combinations of the error level, the user's transaction history, past errors encountered by the user, and/or metrics and related statistical measures associated with the error. Thus, reward selection engine 206 may determine to offer the user a generous statement credit for a future travel-related expense based on the user's transaction history (e.g., frequent travel-related transactions) and the user's history of encountering the error more often than users of the same demographic (e.g., the user has encountered the error 5 times during a 30-day time period, whereas other uses have encountered the same error only 2 times on average during the same time period). Reward selection engine 206 may use logical operations (and may interact with configurable logic engine 202 to perform the operations) in conjunction with information associated with the error and the user's profile to determine whether to offer reward(s) to the user, and the size or amount of any such rewards. The disclosed embodiments are not limited to any particular configuration of reward selection engine 206.

Exemplary system 200 may include an analytics engine 208. In one aspect, analytics engine 208 may be one or more computing devices configured to perform one or more operations consistent with disclosed embodiments. For instance, analytics engine 208 may be configured to generate an internal notification when a user encounters an error. Thus, analytics engine 208 may provide technical support staff and/or management associated with servicing system 114 with details of the error, such as the error type, the seriousness of the error, and error-related metrics and statistics (e.g., the number of other users who have encountered the error).

In one aspect, analytics engine 208 may generate various metrics based on information stored in one or more databases (such as database 326), including, for example: (a) the total number of times users have encountered a particular error over time, (b) the total number of times users have sought assistance after encountering a particular error over time, (c) the total number of times users have been offered a reward after encountering a particular error over time, and the like. In addition, analytics engine 208 may generate metrics related to user demographic information, including, for example: (a) the number of users in a given geographic region, (b) the number of users falling into various income bands, (c) the number of users falling into various spending categories (e.g., categories based on the amount of total annual spend, the amount of annual spending in different areas such as travel, etc.), and the like. Analytics engine 208 may also determine various statistical measures related to the above metrics, such as the mean, median, standard deviation, and the like across all customers who have encountered errors. Thus, for example, analytics engine 208 may determine the average and standard deviation for the number of times users of a particular demographic (e.g., those earning $100,000 or more annually who spend $5,000 or more annually on travel) encounter a particular error (e.g., a payment system error on the payment due date).

In one aspect, analytics engine 208 may analyze a user's transaction history and determine any spending patterns. More specifically, analytics engine 208 may consider the type, frequency, and amount of various transactions to characterize the user's spending patterns. Thus, analytics engine 208 may characterize a user who frequents a particular café twice a week (on average) as a repeat customer of the café. As described above, rewards selection engine 206 may use such information generated by analytics engine 208 in determining which reward(s) to offer to a user. The disclosed embodiments are not limited to any particular configuration of analytics engine 208.

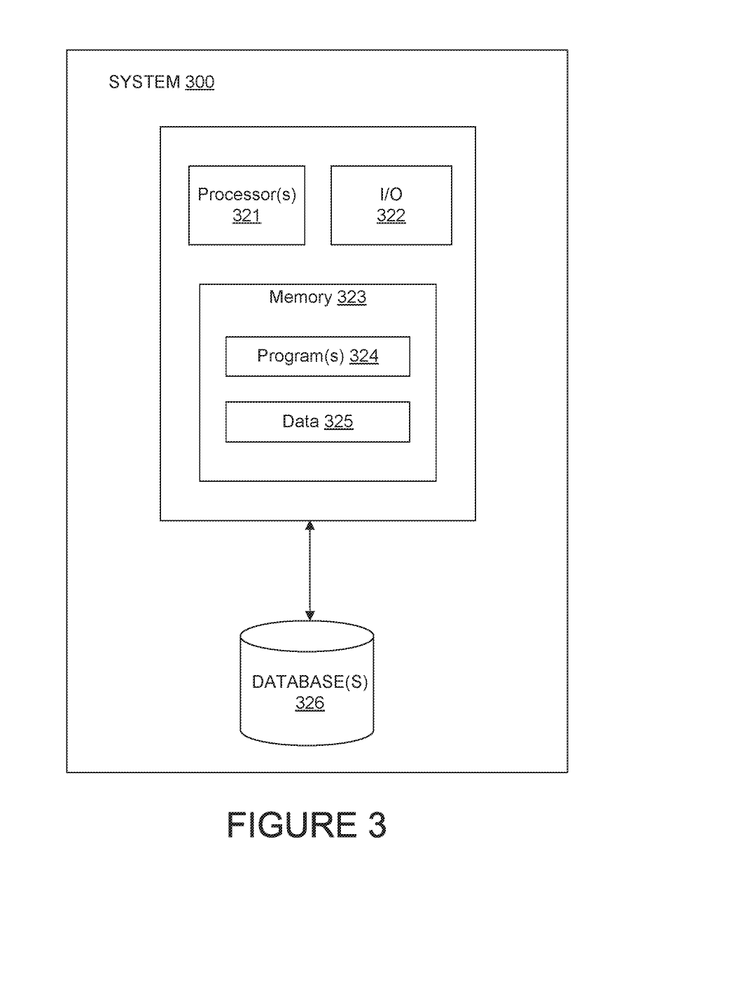

FIG. 3 shows an exemplary system 300 consistent with disclosed embodiments. Variations of exemplary system 300 may be used by financial service provider 110 and/or client 120. In one aspect, system 300 may comprise one or more processors 321, one or more input/output (I/O) devices 322, and one or more memories 323. In some embodiments, system 300 may be configured as a particular apparatus, embedded system, dedicated circuit, and the like based on the storage, execution, and/or implementation of the software instructions that perform one or more operations consistent with the disclosed embodiments.

Processor 321 may include one or more known processing devices, such as mobile device microprocessors from the Pentium™ or Xeon™ family manufactured by Intel™, the Turion™ family manufactured by AMD™, or any of various processors manufactured by Sun Microsystems. The disclosed embodiments are not limited to any type of processor(s) configured in system 300.

Memory 323 may include one or more storage devices configured to store instructions used by processor 321 to perform functions related to the disclosed embodiments. For example, memory 323 may be configured with one or more software instructions, such as program(s) 324 that may enable one or more operations when executed by processor 321. The disclosed embodiments are not limited to separate programs or computers configured to perform dedicated tasks. For example, memory 323 may include a single program 324 that enables the functions of the client 120, or program 324 may comprise multiple programs. Memory 323 may also store data 325 that is used by one or more programs 324.

In certain embodiments, memory 323 may store software that, when executed by processor(s) 321, analyzes errors encountered by users of the financial service provider 110 (such as errors encountered by users while using servicing system 114), determines which actions to take in response to a user-encountered error, and/or determines whether to offer a reward to a user, consistent with disclosed embodiments. The stored software may be run by financial service provider system 112.

I/O devices 322 may be one or more devices configured to allow data to be received and/or transmitted by system 300 over, for example, network 130. I/O devices 322 may include one or more digital and/or analog devices that allow system 300 to communicate with other machines and devices, such as other components of system 100.

I/O devices 322 may also include one or more digital and/or analog devices that allow a user to interact with system 300, such as a touch-sensitive area, keyboard, buttons, or microphones. I/O devices 322 may also include other components known in the art that allow a user to interact with system 300, such as a display, printer, etc. For example, I/O devices 322 may also include a screen for displaying marketing messages, financing options, or providing other information to the user operating system 300.

The components of system 300 may be implemented in hardware, software, or a combination of both hardware and software, as will be apparent to those skilled in the art. For example, although one or more components of system 300 may be implemented as computer processing instructions, all or a portion of the functionality of system 300 may be implemented instead in dedicated electronics hardware.

System 300 may also be communicatively connected to one or more database(s) 326. System 300 may be communicatively connected to database(s) 326 through network 130. Database(s) 326 may include one or more memory devices that store information and are accessed and/or managed through system 300. By way of example, database(s) 326 may include Oracle™ databases, Sybase™ databases, or other relational databases or non-relational databases, such as Hadoop sequence files, HBase, or Cassandra. The databases or other files may include, for example, data and information related to financial records, transaction history data, consumer demographics information, user profile information, error history data, and the like (not pictured). In one aspect, the databases may include log data, such as user data and error data stored when a user encounters an error. Systems and methods of disclosed embodiments, however, are not limited to separate databases. In one aspect, system 300 may include database(s) 326. Alternatively, database(s) 326 may be located remotely from the system 300. Database(s) 326 may include computing components (e.g., a database management system, database server, etc.) configured to receive and process requests for data stored in memory devices of database(s) 326 and to provide data from database(s) 326.

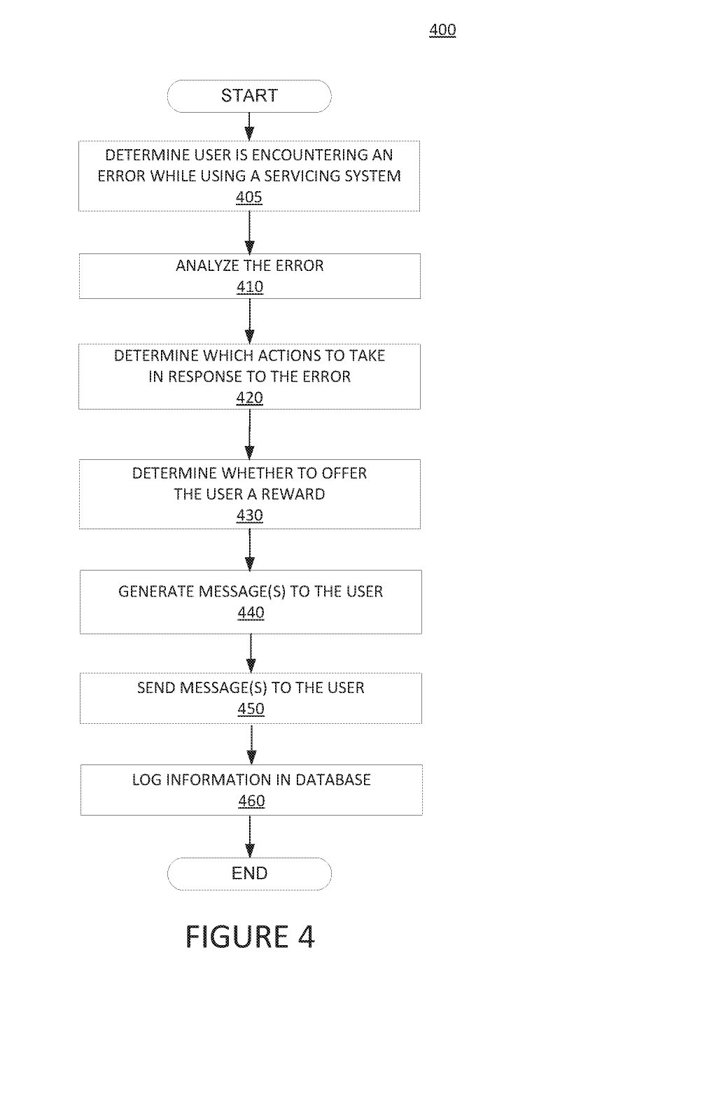

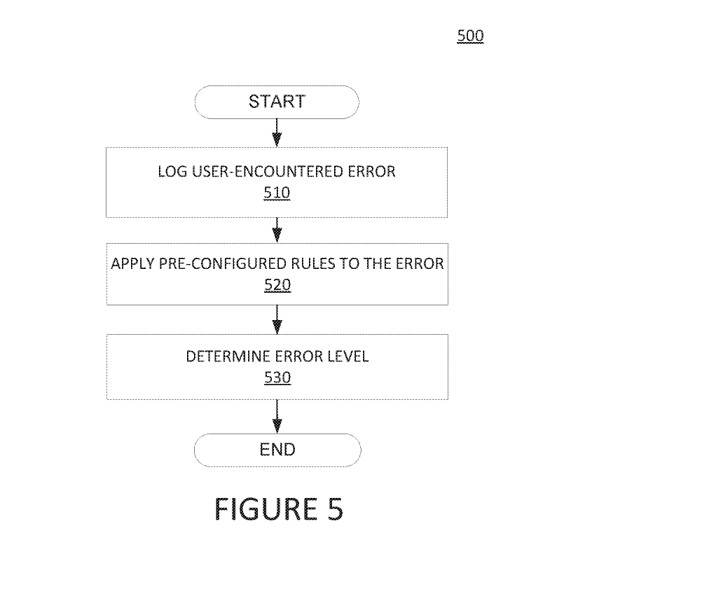

FIG. 4 shows a flow chart of an exemplary process 400 for generating a response when a user encounters an error, consistent with disclosed embodiments. At step 405, financial service provider system 112 may determine that a user (e.g., a user operating client 120 to communicate with servicing system 114) is encountering an error, for instance, while using servicing system 114. A user may encounter an error in various situations, e.g., while submitting a payment, transferring funds, updating user preferences, viewing account activity, etc. Financial service provider system 112 may also analyze an error (step 410) by, for example, determining an error level based on the type, frequency of occurrence, and significance of the error relative to other errors. In one aspect, the relative significance of the error may be based on user data, e.g., the number of times a particular user has encountered the same error or similar errors, how frequently that user seeks assistance, and the like. The encountered error may stem from various system failures. For example, the error may stem from a software programming error or hardware failure associated with financial service provider system 112, servicing system 114, and/or client device 120. Financial service provider system 112 may use configurable logic engine 202 to perform one or more logical operations for determining the error level. An exemplary process for analyzing an error is described in further detail below in reference to FIG. 5.

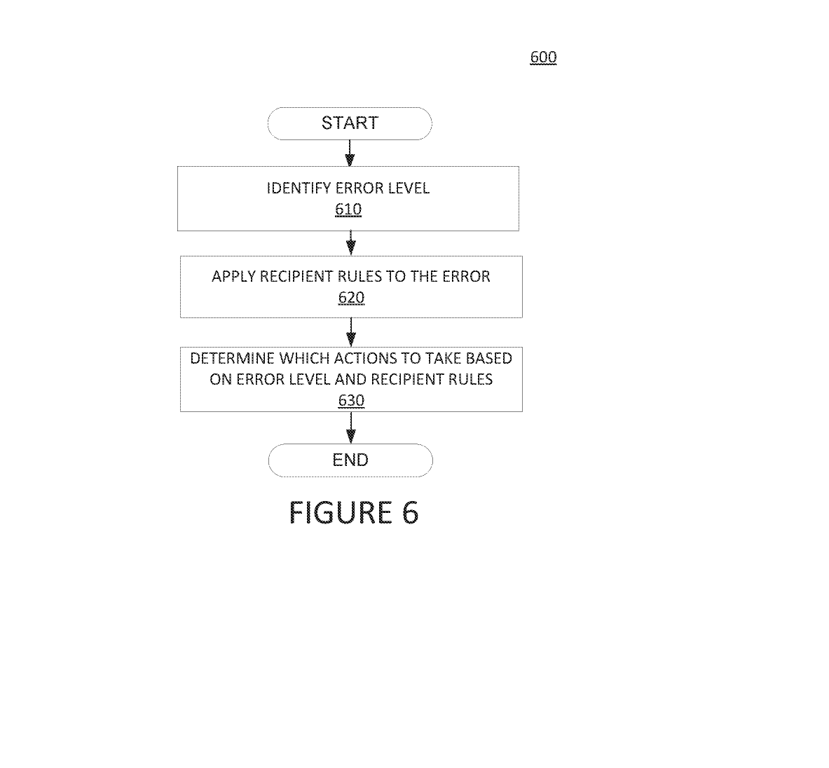

At step 420, financial service provider system 112 may determine one or more actions to take in response to a user-encountered error. Financial service provider system 112 may, for example, initiate a communication with the user via telephone, SMS, e-mail, push notification, browser pop-up, and/or perform additional analysis related to the error. Financial service provider system 112 may use configurable logic engine 202 to perform one or more logical operations involving various factors (e.g., time of day, the user's geographic location, user preferences, etc.) for determining which action(s) to take. Financial service provider system 112 may also use content selection engine 204 to generate one or more messages directed to the user. An exemplary process for determining which action(s) to take in response to a user-encountered error is described in further detail below in reference to FIG. 6.

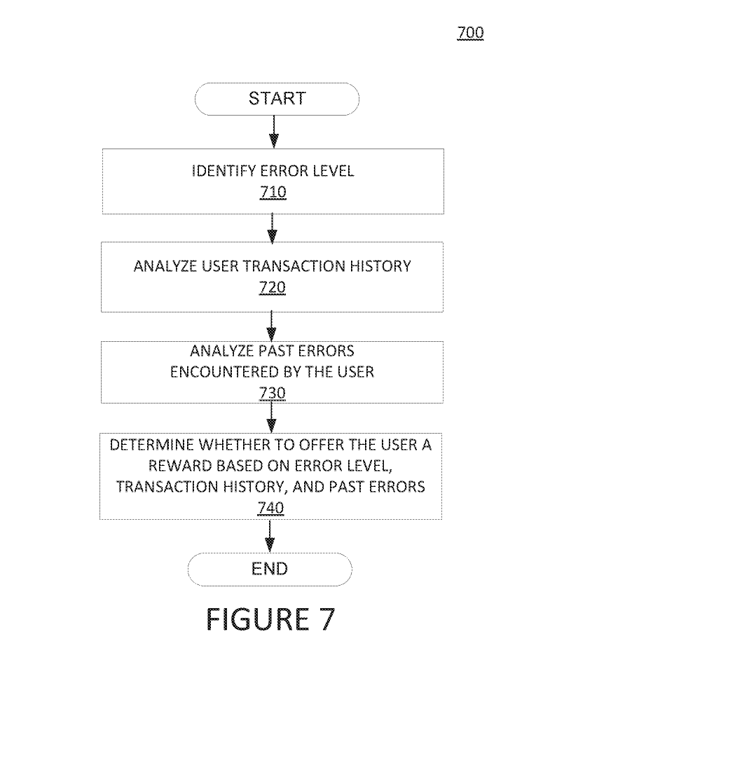

At step 430, financial service provider system 112 may determine whether to offer the user a reward based on, for example, information associated with the error (e.g., the type, frequency of occurrence, and relative significance of the error, etc.) and the user's profile (e.g., transaction history, the number of times the user has called for assistance, spending pattern, etc.). Financial service provider system 112 may use content selection engine 204 and/or reward selection engine 206 to make the determination. An exemplary process for determining whether to offer a reward to a user is described below in reference to FIG. 7.

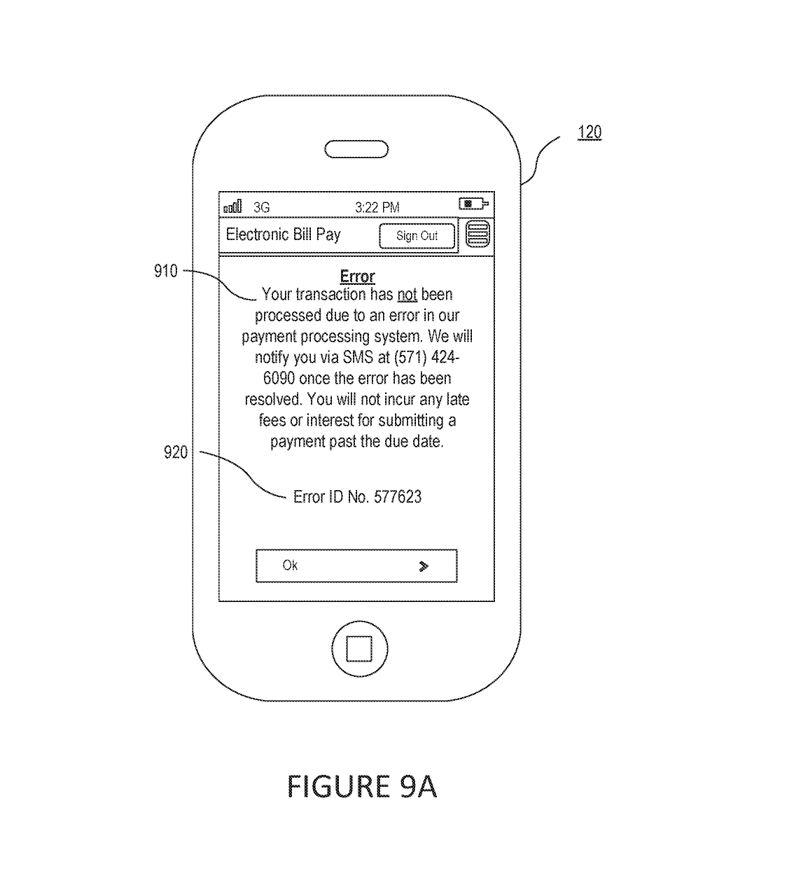

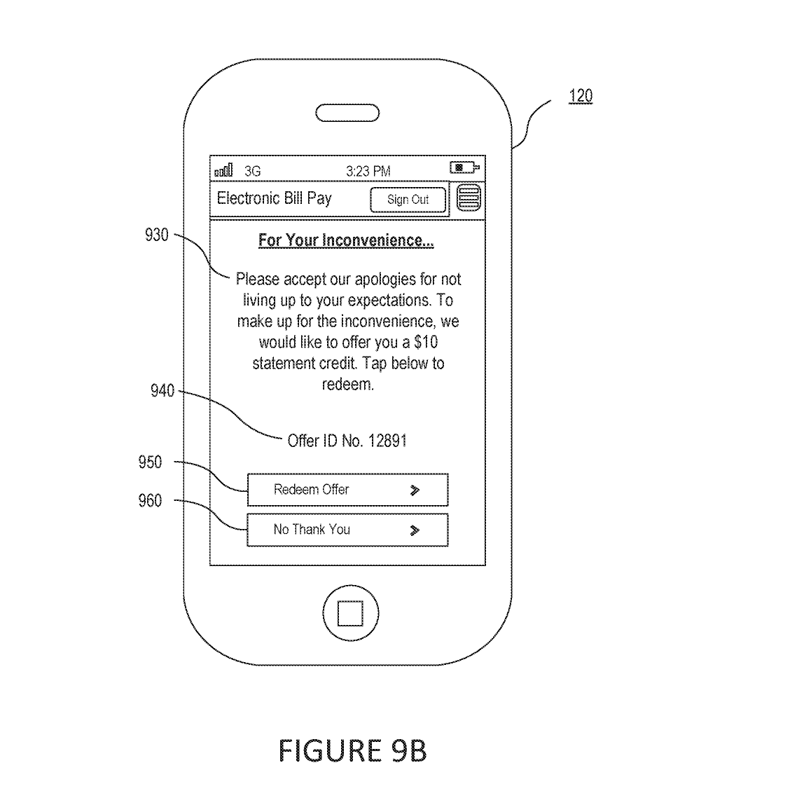

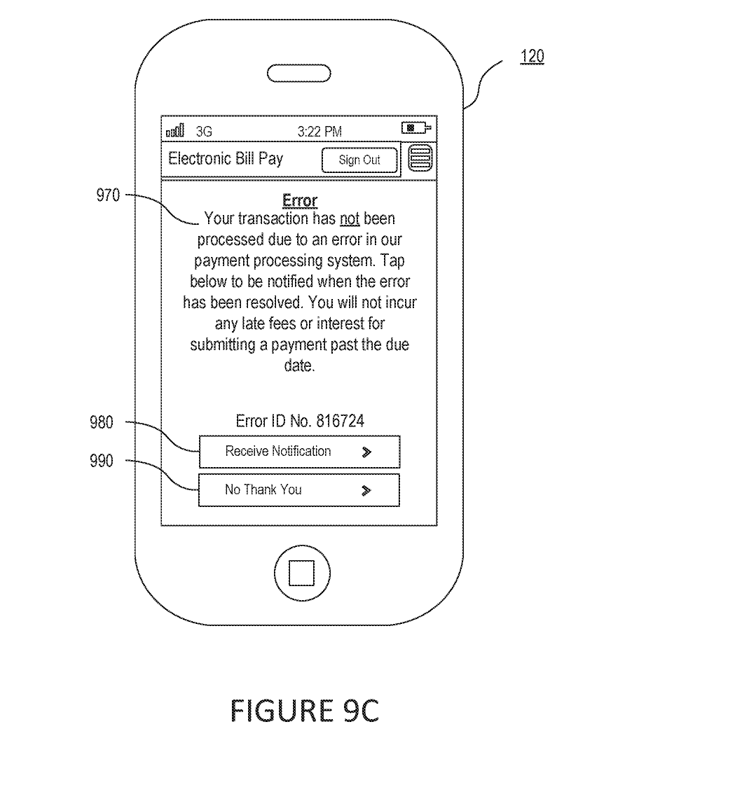

Financial service provider system 112 may generate (step 440) and send (step 450) one or more messages to the user based on the results of steps 420 and 430. For instance, if financial service provider system 112 made the determination to send an error update to the user via SMS (at step 420) and offer the user a statement credit as compensation for the inconvenience to the user (at step 430), financial service provider system 112 may generate and send an SMS to this effect at steps 440 and 450, respectively. Exemplary messages to a user are described below in reference to FIGS. 9A, 9B, and 9C. At step 460, financial service provider system 112 may log information related to the error (e.g., the type of error, the error level, etc.), the user (e.g., the user ID, whether or not the user sought assistance for the error, etc.), and the response to the error (e.g., the type and content of communications to the user, the type and amount of rewards offered to the user, etc.), in a database, such as database 326. In one aspect, financial service provider system 112 may assign a unique transaction identifier corresponding to the error, user, and response information for ease of associating the information together and making future retrieval of the information more convenient. Financial service provider system 112 may also use such information for generating metrics and various statistical measures.

FIG. 5 shows a flow chart of an exemplary error analysis process 500, consistent with disclosed embodiments. A trigger event (e.g., a system failure) may cause financial service provider system 112 to log an error, such as a Java error (step 510). For example, a user's unsuccessful attempt to submit a payment or update their profile (e.g., due to a system error) may trigger financial service provider system 112 to log the error. In some embodiments, financial service provider system 112 may log the error—including, for example, the date and time of the error, the type of error and any associated error codes, information on the user who encountered the error, and the like—in a central logging database (such as database 326). The type and location of the database, as well as the specific information stored in the database, may vary according to disclosed embodiments.

At step 520, financial service provider system 112 may apply one or more pre-configured rules to the error. In one aspect, pre-configured rules may be a numerical ranking associated with different types of errors. For example, using a scale from “1” to “5” (“5” being the highest) a payment system error occurring on or near a payment due date may be assigned a “5,” a non-urgent payment system error may be assigned a “4,” a money transfer error may be assigned a “3,” an error while trying to update user preferences may be assigned a “2,” and so forth. Additionally, such rankings may be adjusted based on different factors. For instance, in the case of a user who has encountered a non-urgent payment system error (which would be assigned a ranking of “4” according to the above example) multiple times in a given week, the error ranking may be bumped up to a “5.” As another example, in the case of a user whose profile contains outdated or inaccurate contact information, an error while trying to update this information (which would be assigned a ranking of “2” according to the above example) may be bumped up to a “4.” Thus, an increase or decrease to a ranking associated with a particular error may be made based on various factors (e.g., the number of times the user has encountered the error—or any error—in a specific period of time, the user's account status or recent activity, etc.) to more accurately reflect the seriousness of the error relative to other errors. Financial service provider system 112 may also determine an error level (step 530) based on the application of the pre-configured rules and the information associated with the error logged at step 510. In one aspect, the error level may be understood as a threshold system used to determine the manner in which to respond to a particular user-encountered error. For example, in a threshold system with the levels “high,” “medium,” and “low,” an error with an error level of “high” may cause financial service provider system 112 to offer the user a reward and/or initiate a phone conversation with the user, whereas an error with an error level of “medium” may cause financial service provider system 112 to generate a message to the user (without offering a reward) and provide an update on how quickly the error will be resolved. A given error level may be associated with one or more responses; various combinations of error levels and responses are possible. In one aspect, financial service provider system 112 may determine an error level by using an assignment of rankings (e.g., as discussed above in step 520) to error levels. For example, financial service provider system 112 may assign an error level of “high” to errors associated with a ranking of “5” or “4,” an error level of “medium” to errors associated with a ranking of “3,” and an error level of “low” to errors associated with a ranking of “2” or “1.” Various assignments of rankings to error levels are possible.

FIG. 6 shows a flow chart of an exemplary process 600 for determining which actions to take in response to a user-encountered error, consistent with disclosed embodiments. At step 610, financial service provider system 112 may identify an error level associated with the error. Financial service provider system 112 may identify the error level determined at step 530 as described in reference to FIG. 5, above. In addition, financial service provider system 112 may apply one or more recipient rules (e.g., rules reflecting user preferences as to notification settings, delivery options, message content, etc.) to the error (step 620). In one aspect, financial service provider system 112 may use recipient rules to determine which actions, if any, to take in response to the error. For example, a particular user may only wish to be contacted when they encounter a relatively serious error, such as an error while trying to submit a payment. Or the user may wish to be contacted each time they encounter an error, but they may prefer to only be contacted through text messages or push notifications on their mobile device. Thus, financial service provider system 112 may take into account recipient rules reflecting user preferences (step 620) and use them to determine which actions to take, if any (step 630, described below).

Based on the application of the recipient rules and the error level, financial service provider system 112 may determine one or more actions to take in response to the error (step 630). In one aspect, financial service provider system 112 may use different combinations of recipient rules and the identified error level, for instance, to make this determination. For example, financial service provider system 112 may determine whether to send a communication to the user via push notification, browser pop-ups, e-mail, SMS, text message, and/or via other digital channels. Thus, financial service provider system 112 may execute one or more logical operations that take into account various factors, such as time of day, the user's geographic location, the user's notification settings, delivery options, message format settings, message content settings, and the like. As an example, financial service provider system 112 may update the user via e-mail when the error is resolved. Financial service provider system 112 may also use the time of day when the error occurred to determine whether or not to initiate a phone call with the user (e.g., call only during regular business hours) if the user's preferences indicate that a phone call is a permissible contact method. As another example, financial service provider system 112 may use the user's geographic location to determine what content to include in a message to the user (e.g., certain errors may be caused by regional or local system failures or outages, certain merchant offers (for rewards) may be limited to a particular region, etc.). Financial service provider system 112 may additionally provide the user with an alternate method to complete the user's desired transaction. For example, a user intending to submit an online payment may be offered the option to submit payment over the phone or via SMS.

In one aspect, financial service provider system 112 may solicit feedback from the user at step 630. Financial service provider system 112 may seek user confirmation, for example, that the one or more mediums used to contact the user are consistent with the user's contact preferences. Thus, financial service provider system 112 may generate a message to the user such as “We are grateful for your business and the opportunity to provide you with high-quality customer service. Please feel free to let us know your preferred method(s) of contact using the check boxes below in the event that you encounter a similar issue in the future.” Financial service provider system 112 may generate such a message with various frequencies, e.g., the first time the system attempts to contact the user in response to an error, each time the system attempts to contact the user, and/or at a frequency based on the user's profile and history of encountering system errors.

In one aspect, if the error is a relatively serious one (e.g., the user is unable to conduct any account transactions), financial service provider system 112 may call the user during regular business hours to assure the user that the error has been logged and is in the process of being resolved, and that the user will be notified once the error has been resolved. Additionally or alternatively, financial service provider system 112 may provide internal notifications to the financial service provider 110. For example, financial service provider system 112 may alert technical support staff and/or management associated with the service system encountering the error for potential further action.

FIG. 7 is a flow chart showing an exemplary process 700 for determining whether to offer a reward to a user, for example, when a user encounters an error, consistent with disclosed embodiments. At step 710, financial service provider system 112 may determine an error level associated with the error (see steps 530 and/or 610, described in reference to FIGS. 5 and 6, respectively, above). At step 720, financial service provider system 112 may conduct an analysis to identify one or more factors associated with determining the type of award to offer the user (if any) by, for example, analyzing the user's transaction history. In one aspect, financial service provider system 112 may identify the user's spending in different categories, e.g., the amount and how frequently the user conducts transactions related to travel, groceries, food and drink, entertainment, retail, and the like. Financial service provider system 112 may also determine whether the user conducts repeated transactions at certain merchants, such as a particular café, grocery store, restaurant, and the like. Thus, in an example where financial service provider system 112 determines to send an award and the user's spending largely falls under the “travel”—category—and under the travel category, with the same airline—financial service provider system 112 may offer the user a statement credit for future travel-related expenses, or a gift card for future travel on the same airline.

Financial service provider system 112 may conduct further analysis to identify additional factors associated with determining the type of award to offer the user (if any) by, for example, analyzing past errors encountered by the user (step 730). For instance, financial service provider system 112 may consider the types of errors previously encountered by the user, how often the user has encountered such errors, and the relative seriousness of such errors compared to other errors. In one aspect, the user's error history may be compared with past error information associated with a plurality of users (e.g., other users associated with other servicing systems 114, other users of the same servicing system 114 with which the user encountered a problem, other users of similar demographics, etc.). Information concerning the user's error history (including past error information associated with the plurality of users) may be stored in a database accessible to financial service provider system 112, such as database 326. Thus, in the case of a user who has experienced a greater number of relatively serious errors compared to other users, financial service provider system 112 may be more likely to offer the user a reward and/or increase the size of the reward.

At step 740, financial service provider system 112 may determine whether to offer the user a reward and, if so, the size or amount of the reward. Financial service provider system 112 may make this determination based on, for example, the determined error level (step 710) and/or the analyses conducted at steps 720 and 730. In one aspect, financial service provider system 112 may use different combinations involving the identified error level, the user's transaction history, and the past errors encountered by the user to make this determination. For instance, financial service provider system 112 may determine to offer a reward to a user who encounters an error exceeding a predetermined error level threshold. Additionally, financial service provider system 112 may determine the type of reward to offer the user (e.g., a gift card for a merchant that the user frequents) based on the user's transaction history and determine the amount or size of the reward based on, for example, the number of times the user has previously encountered the error (or other errors with the same error level, etc.) in a given time period. An exemplary message offering a reward to a user is described in reference to FIG. 9B, below.

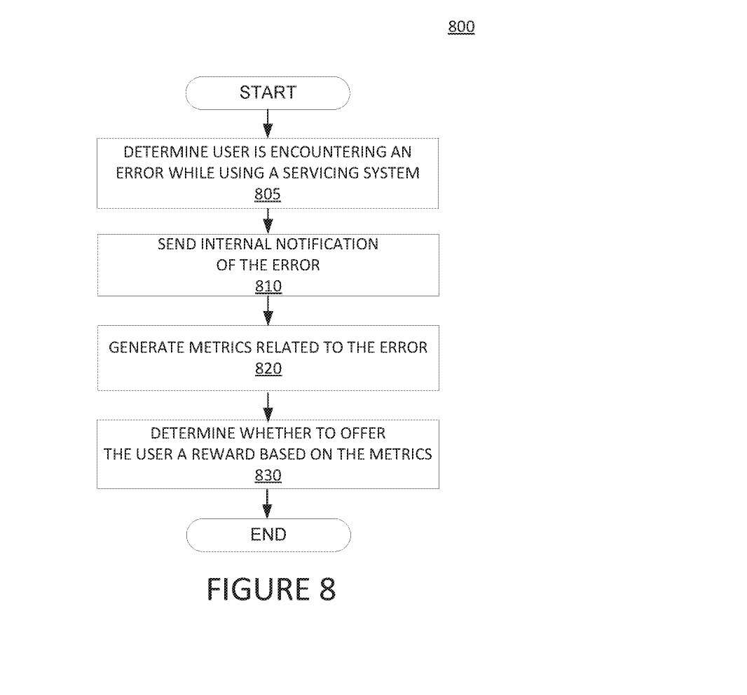

FIG. 8 shows a flow chart of an exemplary error analysis process 800, consistent with disclosed embodiments. At step 805, financial service provider system 112 may determine that a user (e.g., operating client 120) is encountering an error, for instance, while using a servicing system 114 (see step 405, described in reference to FIG. 4, above). At step 810, financial service provider system 112 may generate an internal notification including information regarding the error. For example, financial service provider system 112 may provide technical support staff and/or management associated with servicing system 114 with details of the error, such as the error type, the seriousness of the error, and error-related statistics (e.g., the number of other users who have encountered the error). In this way, for example, the error is promptly brought to the attention of the person(s) within financial service provider 110 best suited to fix servicing system 114 to correct the error and/or avoid future errors.

Financial service provider system 112 may generate one or more metrics related to the error, using, for example, analytics engine 208 (step 820). Such metrics may include, for example: (a) the number of times the user (and/or other users) has encountered this particular error, (b) the number of times the user (and/or other users) has encountered any system error, (c) the number of times the user (and/or other users) has sought assistance for this particular error, (d) the number of times the user (and/or other users) has sought assistance for any system error, (e) the number of times the user (and/or other users) has previously been offered a reward after encountering this particular error, (f) the number of times the user (and/or other users) has previously been offered a reward after encountering any system error, and so forth. Financial service provider system 112 may also determine various statistical measures related to the above metrics, such as the mean, median, standard deviation, and the like.

Based on the generated metrics and/or related statistical measures, financial service provider system 112 may determine whether to offer the user a reward (step 830). For instance, financial service provider system 112 may offer the user a reward in the case where the user has experienced a particular error (or another error with the same error level, etc.) on numerous occasions but has never been offered a reward. In one aspect, financial service provider system 112 may consider additional factors in determining whether to offer the user a reward by, for example, conducting analyses as described in steps 720 and 730 in reference to FIG. 7, above. That is, financial service provider system 112 may determine whether to offer the user a reward based on different combinations of the generated metrics, the statistical measures, the identified error level, the user's transaction history, and/or the past errors encountered by the user. For instance, financial service provider system 112 may determine to offer the user a reward in the case where the error level is relatively low, but where the metrics and statistical measures suggest that the user has encountered the error (or errors in general) significantly more (e.g., one standard deviation more) than other users of the same or similar demographic. As another example, financial service provider system 112 may determine not to offer the user a reward in the case where the user encountered the error for the first time and the metrics and statistical measures suggest that other users of the same or similar demographic have encountered the error (and/or errors with the same error level) much more frequently.

In one aspect, financial service provider system 112 may use the metrics to determine whether the user has encountered errors (and/or a particular error) an unusual number of times relative to other users. For instance, based on an examination of different combinations of the generated metrics and statistical measures (e.g., the mean and standard deviation of the frequency of occurrence for an error, compared to the user's frequency of occurrence for the same error), financial service provider system 112 may determine not to offer the user a reward because there is a significant risk, for example, the user is attempting to trigger reward offers from the system. Thus, financial service provider system 112 may analyze the generated metrics and statistical measures to identify patterns indicating that a user is encountering errors at an unusual rate. In such situations, financial service provider system 112 may alert the user to the unusual error frequency and/or contact the user to resolve the error.

FIGS. 9A, 9B, and 9C show exemplary graphical user interfaces on client 120 for displaying messages to a user, consistent with disclosed embodiments. FIG. 9A, for example, provides an exemplary message (910) sent to a user who has encountered a system error while trying to submit a payment. FIG. 9A further shows an error identification number (“Error ID No.,” 920) associated with the message 910. As another example, FIG. 9B provides an exemplary message (930) offering the user a reward and shows an offer identification number (“Offer ID No.,” 940) associated with the message 930. In one aspect, financial service provider system 112 may store Error ID No. 920 and Offer ID No. 940 in database 326 together with associated user data. As shown in FIG. 9B, the user may tap to redeem the offer (950) or decline the offer (960). FIG. 9C provides an exemplary message (970) informing the user of the option to receive a notification when the error has been resolved. As shown in FIG. 9C, the user may agree to receive a notification (980) or decline (990).

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. Furthermore, one skilled in the art will appreciate that these aspects can also be stored on and executed from many types of tangible (i.e., non-transitory) computer-readable media including RAM or ROM, hard disks, caches, floppy disks, CD-ROM, tape drives, memory sticks, etc.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

1-19. (canceled)

20. A system for determining a reward when the user has encountered an error using a servicing system, the system comprising:
a memory device storing instructions; and
one or more hardware processors configured to execute instructions:
detect that a user has encountered an error using a servicing system based on a trigger event, wherein the trigger event is associated with a system failure;
analyze the error according to a pre-configured rule to determine an error level associated with the error, the error level being based in part on an error history associated with the user;
generate an internal notification of the error to a separate system associated with the servicing system;
generate a metric related to the error based on an analysis of the error;
determine whether to offer a reward to the user based on at least one of information associated with the error and profile information associated with the user;
select the reward to offer the user; and
provide the user with an offer of the selected rewards.

21. The system of claim 20, wherein the information associated with the error comprises at least one of the error level, an error type, a frequency of occurrence of the error, or a relative significance level of the error.

22. The system of claim 20, wherein the profile information associated with the user comprises at least one of a user's transaction history, a number of times the user has sought assistance, communication preferences, or a user's spending pattern.

23. The system of claim 20, wherein the reward comprises at least one of a gift card, bonus loyalty points, rewards program points, a statement credit, or an exclusive merchant offer.

24. The system of claim 20, wherein the one or more processors are further configured to execute the instructions to:
analyze the user's transaction history;
identify an interest of the user based on the analysis; and
select the reward to offer based on the identified the interest to tailor the offer to the user.

25. The system of claim 20, wherein the one or more processors are further configured to execute the instructions to:
determine the error level based in part on a frequency of the error being encountered by the user in a predetermined period of time.

26. The system of claim 20, wherein the one or more processors are further configured to execute the instructions to:
identify a recipient rule reflecting user preferences for being contacted based in part on an error level; and
select a response to the error based on a recipient rule, wherein the response of is directed to the user in real-time.

27. The system of claim 20, wherein the one or more processors are further configured to execute the instructions to:
determine whether to offer a reward to the user if the user has previously experienced the error and a number of times the user has not receive a reward.

28. The system of claim 20, wherein the one or more processors are further configured to execute the instructions to:
identify that the user is attempting to frequently trigger the reward from the system based on the frequency of the error for a plurality of users and the frequency of the error for the user.

29. A method for determining a reward when the user has encountered an error using a servicing system, the method comprising:
detecting that a user has encountered an error using a servicing system based on a trigger event, wherein the trigger event is associated with a system failure;
analyzing the error according to a pre-configured rule to determine an error level associated with the error, the error level being based in part on an error history associated with the user;
generating an internal notification of the error to a separate system associated with the servicing system;
generating a metric related to the error based on an analysis of the error;
determining whether to offer a reward to the user based on at least one of information associated with the error and profile information associated with the user;
selecting the reward to offer the user; and
providing the user with an offer of the selected rewards.

30. The method of claim 29, wherein the information associated with the error comprises at least one of the error level, an error type, a frequency of occurrence of the error, or a relative significance level of the error.

31. The method of claim 29, wherein the profile information associated with the user comprises at least one of a user's transaction history, a number of times the user has sought assistance, communication preferences, or a user's spending pattern.

32. The method of claim 29, wherein the reward comprises at least one of a gift card, bonus loyalty points, rewards program points, a statement credit, or an exclusive merchant offer.

33. The method of claim 29, further comprising:
analyzing the user's transaction history;
identifying an interest of the user based on the analysis; and
selecting the reward to offer based on the identified the interest to tailor the offer to the user.

34. The method of claim 29, further comprising:
determining the error level based in part on a frequency of the error being encountered by the user in a predetermined period of time.

35. The method of claim 29, further comprising:
identifying a recipient rule reflecting user preferences for being contacted based in part on an error level; and
selecting a response to the error based on a recipient rules, wherein the response of is directed to the user in real-time.

36. The method of claim 29, further comprising:
determining whether to offer a reward to the user if the user has previously experienced the error and a number of times the user has not receive a reward.

37. The method of claim 29, further comprising:
identifying that the user is attempting to fraudulently trigger the reward from the system based on the frequency of the error for a plurality of users and the frequency of the error for the user.

38. A non-transitory computer readable medium storing instructions that, when executed by one or more hardware processors, configures the one or more hardware processors to perform operations for determining a reward when the user has encountered an error using a servicing system, the operations comprising:
detecting that a user has encountered an error using a servicing system based on a trigger event, wherein the trigger event is associated with a system failure;
analyzing the error according to a pre-configured rule to determine an error level associated with the error, the error level being based in part on an error history associated with the user;
generating an internal notification of the error to a separate system associated with the servicing system;
generating a metric related to the error based on an analysis of the error;
determining whether to offer a reward to the user based on at least one of information associated with the error and profile information associated with the user;
selecting the reward to offer the user; and
providing the user with an offer of the selected rewards.

39. The non-transitory computer readable medium of claim 38, the operations further comprising:
identifying a recipient rule reflecting user preferences for being contacted based in part on an error level; and
selecting a response to the error based on the recipient rule, wherein the response of is directed to the user in real-time.
